(19) United States
(12) Patent Application Publication
(10) Pub. No.: US 2017/0273333 A1
(43) Pub. Date: Sep. 28, 2017

(54) HEAT-RESISTANT CHOCOLATE AND METHOD FOR MANUFACTURING THE SAME

(71) Applicant: The Nisshin OilliO Group, Ltd., Chuo-ku, Tokyo (JP)

(72) Inventors: Kiyomi OONISHI, Yokosuka-shi, Kanagawa (JP); Yuuko TOYAMA, Yokosuka-shi, Kanagawa (JP); Noriko MURAYAMA, Yokosuka-shi, Kanagawa (JP)

(73) Assignee: The Nisshin OilliO Group, Ltd., Chuo-ku, Tokyo (JP)

(21) Appl. No.: 15/510,819

(22) PCT Filed: Sep. 10, 2015
(86) PCT No.: PCT/JP2015/075721

§ 371 Date: Mar. 13, 2017

(30) Foreign Application Priority Data
Sep. 24, 2014 (JP) 2014-193489

(51) Int. Cl. A23G 1/40; A23G 1/46; A23G 1/00; A23G 1/36

(52) U.S. Cl. CPC A23G 1/40; A23G 1/36; A23G 1/46; A23G 1/0006

(57) ABSTRACT

The present invention is intended to provide chocolate being less susceptible to a change in process conditions and having remarkably excellent heat resistance and the method for manufacturing such chocolate. The present invention relates to chocolate having a sugar skeleton and containing the following (a) to (d): (a) 28 to 44 mass % of fats and oils; (b) 30 to 58 mass % of sucrose; (c) 1 to 20 mass % of lactose; and (d) 4 to 32 mass % of powdered milk.

### TECHNICAL FIELD

The present invention relates to heat-resistant chocolate and the method for manufacturing such chocolate.

### BACKGROUND ART

The culture of eating chocolate has been developed in Europe with a cold climate. Currently, such a culture has spread across any countries and regions around the world. Typical chocolate contains, as fats and oils, only cocoa butter contained in cacao beans. The heatproof temperature of such chocolate is about 31° C. Thus, under hot environment, the chocolate is melted, and the quality of the chocolate is impaired. For this reason, in hot regions such as regions near the equator, there are needs for chocolate (hereinafter referred to as “heat-resistant chocolate”) having heat resistance.

Examples of the method for providing heat resistance to chocolate include a method in which high melting point fats and oils are blended with chocolate, a method in which a solid content in chocolate is increased (fats and oils are decreased), and a method in which a small amount of water is mixed with chocolate mix to form a sugar skeleton. Blending of the high melting point fats and oils leads to remarkably degraded melting mouthfeel of the chocolate. An increase in the solid content in the chocolate leads to degraded chocolate texture. Formation of the sugar skeleton in chocolate can provide the heat resistance to the chocolate without degrading the melting mouthfeel and the texture. However, mixture of the small amount of water with the chocolate mix causes a viscosity increase, leading to lower productivity. Moreover, variation in the heat resistance of the chocolate is easily caused.

For reducing an increase in the viscosity of the chocolate mix described above, a method in which glycerol or sorbitol is mixed instead of water (e.g., U.S. Pat. No. 6,488,979) and a method in which a water-in-oil emulsion is mixed (e.g., U.S. Pat. No. 6,165,540) have been known, for example. However, even by these methods, there is still a great viscosity increase, and for this reason, variation in the heat resistance is easily caused. For providing chocolate having excellent heat resistance, strict process management and long-term temperature adjustment (curing) for sugar skeleton stabilization need to be performed.

### CITATION LIST

### Patent Literature

PATENT LITERATURE 1: U.S. Pat. No. 6,488,979
PATENT LITERATURE 2: U.S. Pat. No. 6,165,540

### SUMMARY OF THE INVENTION

### Problems to be Solved by the Invention

The present invention is intended to provide chocolate being less susceptible to a change in process conditions and having remarkably excellent heat resistance and the method for manufacturing such chocolate.

### Solution to the Problems

As a result of diligent studies, the inventor(s) of the present invention has found, upon completion of the present invention, that a strong sugar skeleton is easily formed in chocolate containing predetermined contents of fats and oils, sucrose, lactose, and powdered milk. More specifically, the present invention provides the following chocolate and the following method for manufacturing the chocolate.

[1] Chocolate having a sugar skeleton, containing:

(a) 28 to 44 mass % of fats and oils;

(b) 30 to 58 mass % of sucrose;

(c) 1 to 20 mass % of lactose; and

(d) 4 to 32 mass % of powdered milk.

[2] The chocolate according to [1], in which the shape of the chocolate is retained for equal to or longer than 24 hours in the state in which the chocolate is dipped in n-hexane at 20° C.

[3] The chocolate according to [1] or [2], in which the chocolate has resistance to stress under load of equal to or greater than 100 g, the resistance to stress under load being measured in such a manner that chocolate temperature-adjusted to 34° C. and having a thickness of 7 mm is measured using a rheometer under conditions including a table moving speed of 20 mm/min, a fixed depth of 3.0 mm, and a plunger diameter of 3 mm.

[4] The chocolate according to any one of [1] to [3], in which the powdered milk is skimmed milk powder and/or whole milk powder.

[5] The method for manufacturing chocolate having a sugar skeleton, including: the process of adding and dispersing 0.3 to 3.0 mass % of water with respect to 100 parts by mass of melted chocolate and cooling and solidifying the melted chocolate, the melted chocolate containing

(a) 28 to 44 mass % of fats and oils,

(b) 30 to 58 mass % of sucrose,

(c) 1 to 20 mass % of lactose, and

(d) 4 to 32 mass % of powdered milk.

[6] The method for manufacturing the chocolate having the sugar skeleton according to [5], further including the heat retention process of heat-retaining the chocolate after the cooling and solidifying process.

### Effects of the Invention

According to the present invention, chocolate having remarkably excellent heat resistance is provided. Moreover, according to the present invention, the method for manufacturing chocolate having remarkably excellent resistance is provided.

### DESCRIPTION OF EMBODIMENT

An embodiment of the present invention will be described in detail below. Note that the present invention is not limited to the embodiment described below.

<Chocolate>

In the present invention, “chocolate” is not limited by “Fair Competition Codes concerning Labeling on Chocolate and/or Chocolate-Like Food” (Japan Chocolate Industry Fair Trade Conference) or legal provisions, for example. The chocolate of the present invention indicates chocolate containing edible fats and oils and saccharides as main raw materials, additionally containing, if needed, cacao components (e.g., cacao mass and cocoa powder), dairy products, flavors, emulsifiers, etc., and manufactured through some or all of chocolate manufacturing processes (a mixing process, a refining process, a conching process, a temperature adjustment process, a molding process, a cooling process, etc.). Moreover, the chocolate of the present invention includes not only milk chocolate but also white chocolate and colored chocolate.

The chocolate of the present invention contains 28 to 44 mass % of fats and oils. The fats and oils as described herein collectively indicate all of fats and oils including not only fats and oils such as cocoa butter but also fats and oils contained in raw materials of chocolate, such as cacao mass, cocoa powder, and whole milk powder. In general, the content of the fats and oils (cocoa butter) in the cacao mass is 55 mass % (an oil percentage of 0.55), the content of the fats and oils (cocoa butter) in the cocoa powder is 11 mass % (an oil percentage of 0.11), and the content of the fats and oils (milk fat) in the whole milk powder is 25 mass % (an oil percentage of 0.25), for example. Thus, the content of the fats and oils in the chocolate is a value obtained by summing up of values each obtained by multiplying the blending amount (mass %) of each raw material in the chocolate by an oil percentage. Considering workability and flavor, the content of the fats and oils in the chocolate of the present invention is preferably 30 to 40 mass %, more preferably 31 to 39 mass %, and much more preferably 32 to 38 mass %.

The chocolate has a continuous phase of the fats and oils. Thus, the content of the fats and oils in the chocolate greatly influences viscosity. A greater content of the fats and oils results in a lower viscosity. Thus, an influence of a viscosity increase caused due to water addition can be reduced. However, a decrease in a sugar percentage results in a brittle sugar skeleton structure. As a result, there is a probability that the heat resistance of the resultant chocolate is lowered. On the other hand, when the fats and oils content is equal to or less than 30 mass %, the viscosity of the chocolate becomes higher. Moreover, the influence of the viscosity increase due to water addition becomes greater. For this reason, there is a probability that handleability in chocolate manufacturing is lowered. Note that such handleability lowering can be reduced in such a manner that emulsifiers (e.g., lecithin and polyglycerin condensed-ricinoleic acid ester (PGPR)) with a viscosity reduction effect are blended with the chocolate to adjust the viscosity as necessary. The content of the emulsifiers with the viscosity reduction effect in the chocolate is preferably 0.2 to 1 mass %. Particularly preferably, the lecithin and the PGPR are used in combination. The lecithin and the PGPR are preferably used in combination within a mass ratio range of 4:6 to 8:2.

The chocolate of the present invention may be of a tempered type or a non-tempered type. In the case of blending much cocoa butter, the tempered type chocolate is preferable. In the case of the tempered type, the fats and oils contained in the chocolate preferably contain SOS triacylglycerol (hereinafter sometimes referred to as “SOS”). The SOS triacylglycerol as described herein is triacylglycerol formed such that saturated fatty acid (S) is bound to first and third positions of a glycerol skeleton and that oleic acid (O) is bound to a second position of the glycerol skeleton. The saturated fatty acid (S) is preferably saturated fatty acid having equal to or greater than 16 carbons, more preferably saturated fatty acid having 16 to 22 carbons, and much more preferably saturated fatty acid having 16 to 18 carbons. In the case of the tempered type chocolate, the SOS content of the fats and oils contained in the chocolate is preferably 40 to 90 mass %, more preferably 50 to 90 mass %, and much more preferably 60 to 90 mass %.

The chocolate of the present invention contains, as one of the saccharides, 30 to 58 mass % of sucrose. In the present invention, the sucrose in the chocolate is one of significant components forming a sugar skeleton. It is appropriate to use powdered sugar as the sucrose, the powdered sugar being formed in such a manner that granulated sugar as crystals of the sucrose is substantially powdered. The content of the sucrose in the chocolate of the present invention is preferably 32 to 54 mass % and more preferably 34 to 50 mass %. The content of the sucrose in the chocolate preferably falls within the above-described range because the sugar skeleton is easily formed in the chocolate.

The chocolate of the present invention contains, as one of the saccharides, 1 to 20 mass % of lactose. In the present invention, the lactose in the chocolate is one of the significant components forming the sugar skeleton. The lactose is preferably crystalline, and is preferably blended as lactose crystals. Almost all types of commercially-available lactose are crystalline. The lactose crystals may be α-lactose or β-lactose. The α-lactose may be anhydrate or monohydrate. The content of the lactose in the chocolate of the present invention is preferably 2 to 18 mass %, more preferably 3 to 16 mass %, and much more preferably 4 to 14 mass %. The content of the lactose in the chocolate preferably falls within the above-described range because a strong sugar skeleton is easily formed in the chocolate. Note that by powder X-ray diffractometry, it can be checked whether or not the lactose is crystalline. That is, when the lactose is crystalline, multiple large peaks around 20° and diffraction peaks at 10.5° (β-type crystal) and 12.5° (α-type crystal monohydrate) are observed as 20 measured by a X-ray diffraction device (X-ray wavelength: λ=1.5405 Å). A crystal portion in the lactose is preferably equal to or greater than 60 mass % and more preferably equal to or greater than 80 mass %.

The chocolate of the present invention contains 4 to 32 mass % of powdered milk. As long as the powdered milk used in the present invention is powder derived from milk, such powdered milk is not particularly limited. Examples of the powdered milk include whole milk powder, skimmed milk powder, whey powder, cream powder, and butter milk powder. One or more types of the powdered milk can be selected and used. In particular, the whole milk powder, the skimmed milk powder, or the whey powder is preferably contained, and the whole milk powder or the skimmed milk powder is more preferably contained. As in the above-described powdered milk examples, the powdered milk used for the chocolate of the present invention is preferably manufactured by spraying and drying using a spray dryer, for example. The content of the powdered milk in the chocolate of the present invention is preferably 8 to 28 mass % and more preferably 12 to 24 mass %. The content of the powdered milk in the chocolate preferably falls within the above-described range because flavor and shape retention properties of the chocolate are favorable.

As long as the features of the present invention are not impaired, the chocolate of the present invention may contain not only the above-described components (the fats and oils, the sucrose, the lactose, and the powdered milk) but also various ingredients or various modifiers normally used for the chocolate. Examples of these ingredients and modifiers include not only cacao mass, cocoa powder, saccharides, dairy products (milk solids etc.), emulsifiers, flavors, and colorings, but also starches, gums, thermocoagulable protein, and various powders such as strawberry powder and green tea powder.

In the chocolate of the present invention, the strong sugar skeleton is formed. Thus, the chocolate of the present invention has remarkably excellent heat resistance. For example, even when the chocolate of the present invention is dipped in n-hexane at 20° C., such chocolate preferably retains the shape thereof for equal to or longer than 24 hours. This indicates that the fats and oils are sealed in the strong sugar skeleton contained in the chocolate. More preferably, the chocolate of the present invention retains, as an indication of the excellent heat resistance (the strong sugar skeleton), the shape thereof for equal to or longer than 72 hours even when the chocolate is dipped in the n-hexane at 20° C. Much more preferably, the chocolate of the present invention retains the shape thereof for equal to or longer than 120 hours. Note that shape retention described herein indicates a state in which more than the half of the chocolate retains the shape thereof without misshaping in the n-hexane.

Preferably, the strong sugar skeleton is formed in the chocolate of the present invention, and therefore, the chocolate of the present invention has resistance to stress under load of equal to or greater than 100 g measured by a rheometer. The resistance to stress under load described herein is measured using the rheometer. Chocolate molded to a thickness of 7 mm and temperature-adjusted to 34° C. is used as a sample. The resistance to stress under load is measured using the rheometer (e.g., manufactured by Sun Scientific Co., Ltd. and product name: CR-500DX) under conditions including a table moving speed of 20 mm/min, a fixed depth of 3.0 mm, and a plunger diameter of 3 mm. A greater value of the resistance to stress under load measured by the rheometer results in a stronger sugar network. The resistance to stress under load of the chocolate of the present invention measured by the rheometer is more preferably equal to or greater than 150 g and much more preferably equal to or greater than 200 g. The upper limit of the resistance to stress under load measured by the rheometer is not particularly limited. Note that for maintaining further pleasant melting mouthfeel, the resistance to stress under load is preferably equal to or less than 600 g and more preferably equal to or less than 400 g.

<Method for Manufacturing Chocolate>

The chocolate of the present invention can be, according to a common procedure, manufactured in such a manner that mixing of the raw materials such as the fats and oils, the sucrose, the lactose, and the powdered milk and refining by roll refining are performed and that conching treatment is performed as necessary, for example. In the case of performing the conching treatment, heating in the conching treatment is preferably performed at 40 to 60° C. not to destroy the flavor of the chocolate. Note that in the manufacturing method of the present invention, the terms “process” and “treatment” are used as having the same meaning.

The method for manufacturing the chocolate of the present invention includes the process (the water addition process) of adding and dispersing water in melted chocolate. The melted state described herein indicates a state in which the fats and oils in the chocolate are melted. In the case of the tempered type chocolate, the melted state of the chocolate can be determined by checking of removal of cooled and solidified chocolate from a mold. When the cooled and solidified chocolate is not removed from the mold (specifically, when the ratio of demolding of chocolate mix from the mold is less than 70%), it is determined that the chocolate is in the melted state.

[Water Addition Process]

In the method for manufacturing the chocolate of the present invention, the temperature of the melted chocolate in the water addition process is, in the case of the non-tempered type chocolate, preferably 30 to 70° C., more preferably 35 to 60° C., and much more preferably 35 to 50° C. Moreover, the same applies to the case of the tempered type chocolate and the case of performing later-described seeding treatment after the water addition process. Note that in the case of performing the water addition process after later-described tempering treatment or the seeding treatment, the temperature of the melted chocolate is preferably 24 to 42° C., more preferably 28 to 40° C., and much more preferably 30 to 38° C.

The amount of the water added in the water addition process is not limited, and may be an amount used in a common water-containing heat-resistant chocolate. Such a water addition amount may be 0.1 to 5.0 mass % with respect to the melted chocolate. When the water addition amount is equal to or greater than 0.1 mass % with respect to the melted chocolate, the sugar skeleton is sufficiently formed, and therefore, the chocolate having the excellent heat resistance is provided. When the water addition amount is equal to or less than 5.0 mass % with respect to the melted chocolate, the risk of microbial contamination can be reduced. The water addition amount may fall, with respect to the melted chocolate mix, within any of ranges of 0.3 to 3.0 mass %, 0.5 to 2.5 mass %, and 0.5 to 1.5 mass %.

Moreover, the content of the water in the melted chocolate after water addition is preferably 0.8 to 3.5 mass %, more preferably 0.9 to 2.5 mass %, and much more preferably 1 to 1.6 mass %. The same content applies to the content of the water in the chocolate in a final state.

The water added in the water addition process may only be water. Note that a composition (hereinafter referred to as a “water-containing material”) containing other components than the water in addition to the water may be used. Depending on the components added together with the water in the water addition process, the speed of increasing the viscosity of the melted chocolate varies even when the same addition amount is applied. Specifically, when only water or a water-containing material (e.g., fruit juice or milk) having a great water content is added, the viscosity of the chocolate easily rapidly increases. On the other hand, when a water-containing material such as liquid sugar or liquid protein is added, the viscosity tends to increase relatively gently. When the viscosity increases rapidly, there is a probability that the water cannot sufficiently disperse in the melted chocolate. For this reason, the water in the water addition process is preferably the water-containing material, and is particularly the liquid sugar or the liquid protein.

Examples of the liquid sugar include liquid solutions, such as reduced sugar syrup and fructose glucose liquid sugar and a sorbitol solution, containing water and sugar such as fructose, glucose, sucrose, maltose, and oligosaccharide. Examples of the liquid protein include liquid solutions containing water and protein such as egg white meringue, concentrated milk, and dairy cream. The content of moisture contained in the liquid sugar or the liquid protein may fall, with respect to the entire liquid solution, within any of ranges of 10 to 90 mass % and 10 to 50 mass %. In the case of adding the water in the form of the water-containing material in the water addition process, the water-containing material may be added such that the amount of the water with respect to the melted chocolate falls within the above-described range.

The temperature of the water and the water-containing material used in the water addition process is not particularly limited. Note that such a temperature is preferably the same temperature as the temperature of the melted chocolate to which the water or the water-containing material is to be added, considering that the temperature of the melted chocolate is easily maintained constant and that the water or the water-containing material is easily uniformly dispersed. After the water has been added to the melted chocolate, the water may be uniformly dispersed in the chocolate by, e.g., stirring.

[Cooling and Solidifying Process]

After the water addition process, the melted chocolate may be cooled and solidified. By such a process, solid chocolate is efficiently manufactured from the melted chocolate.

A cooling and solidifying method is not particularly limited. According to chocolate product properties such as molding and food coating, cooling and solidifying can be performed by cold air spraying in a cooling tunnel or contact with a cooling plate (see, e.g., “Confectionery Fats Handbook” (translated by Iwao Hachiya and issued by Saiwai Shobo Co., Ltd. in 2010)), for example.

Cooling and solidifying conditions are not particularly limited as long as the melted chocolate is solidified. For example, cooling and solidifying may be performed for 5 to 90 minutes (preferably 10 to 60 minutes) at 0 to 20° C. (preferably 0 to 10° C.), for example.

[Heat Retention Process]

The method for manufacturing the chocolate of the present invention preferably employs the “heat retention process” of further performing “heat retention treatment” of the cooled and solidified chocolate. In the heat retention treatment, the cooled and solidified chocolate is heat-retained preferably at 24 to 36° C., more preferably at 26 to 34° C., and much more preferably at 28 to 32° C., preferably for 1 to 240 hours, more preferably for 6 to 144 hours, and much more preferably for 12 to 96 hours. The heat retention treatment allows formation of a stronger sugar skeleton in the chocolate. Moreover, for the cooled and solidified chocolate targeted for the heat retention treatment, pre-aging treatment may be, after cooling and solidifying and before the heat retention treatment, performed preferably at 16 to 24° C. and more preferably at 18 to 22° C., preferably for 6 to 240 hours and more preferably for 12 to 192 hours.

Aging treatment may be, after the cooling and solidifying process or the heat retention process, performed for the heat-resistant chocolate of the present invention. The aging treatment is the treatment of leaving standing the chocolate preferably at 16 to 24° C. and more preferably at 18 to 22° C., preferably for 6 to 240 hours and more preferably for 12 to 192 hours.

The chocolate of the present invention is chocolate having heat resistance. Note that the chocolate of the present invention is different from so-called baked chocolate. For this reason, heating treatment at equal to or higher than 60° C. (preferably equal to or higher than 50° C.) is not required.

In the case where the chocolate of the present invention is of the tempered type in the method for manufacturing the chocolate of the present invention, the tempering treatment or the seeding treatment may be performed before or after the water addition process.

In the tempering treatment, the operation of generating a crystal nucleus of a stable crystal in the melted chocolate is performed. Specifically, the operation of decreasing, to about 27 to 28° C., the initial temperature of the chocolate melted at 40 to 50° C. and re-heating the chocolate to about 29 to 31° C. has been known, for example. The tempering treatment is preferably performed before the water addition process.

The seeding treatment is the treatment of generating, instead of the tempering treatment, a crystal nucleus of a stable crystal in the melted chocolate by using a seeding agent functioning as the crystal nucleus of the stable crystal. As in the tempering treatment, the seeding treatment is performed for solidifying the fats and oils in the chocolate as a stable crystal form V.

In the case of performing the seeding treatment in the method for manufacturing the chocolate of the present invention, the fats and oils in the chocolate preferably contains, as part or the entirety of the SOS, 1,3-distearoyl-2-oleoylglycerol (StOSt) for the purpose of more efficiently providing a seeding effect. The StOSt content of the fats and oils in the melted chocolate of the present invention before seeding falls preferably within a range of 24 to 70 mass %, more preferably 26 to 70 mass %, much more preferably 27 to 60 mass %, and still much more preferably 30 to 55 mass %. When the StOSt content falls within the above-described range, a suitable seeding effect can be more efficiently provided without degrading the melting mouthfeel of the chocolate. When the StOSt content in the chocolate falls within the above-described range, sufficient heat resistance is provided to the chocolate after cooling and solidifying (i.e., sticky texture is reduced when the chocolate is picked up). In addition, favorable melting mouthfeel and favorable bloom resistance of the resultant chocolate can be provided.

In the case of performing the seeding treatment in the method for manufacturing the chocolate of the present invention, a seeding agent containing at least β-type XOX crystals is also added. In this case, “X” represents saturated fatty acid having 16 to 22 carbons, and “O” represents oleic acid. That is, “XOX” represents triacylglycerol having oleic acid bound to a second position of glycerol and X bound to first and third positions of the glycerol. The XOX is preferably 1,3-dibehenyl-2-oleoylglycerol (BOB) or StOSt, and more preferably StOSt. Note that by the powder X-ray diffractometry, it can be checked whether or not XOX crystals are of a β type.

The seeding agent may be a seeding agent containing β-type XOX crystals. In addition to the β-type XOX crystals, the seeding agent may contain other fats and oils (e.g., sunflower oil or palm olein) or solid contents (e.g., saccharides or powdered milk), for example. In light of easily providing the seeding effect, the β-type XOX crystals in the seeding agent are preferably equal to or greater than 10 mass % and more preferably equal to or greater than 30 mass %. The upper limit of the amount of the β-type XOX crystals in the seeding agent is not particularly limited, and is preferably equal to or less than 100 mass %. In light of enhancing handling suitability and dispersibility in the chocolate mix, the β-type XOX crystal amount is preferably equal to or less than 50 mass %.

In the case of performing the seeding treatment in the method for manufacturing the chocolate of the present invention, the amount of the β-type XOX crystals added to the melted chocolate is, with respect to the fats and oils in the chocolate, preferably 0.1 to 15 mass %, more preferably 0.2 to 8 mass %, and much more preferably 0.3 to 3 mass %. When the addition amount of the β-type XOX crystals falls within the above-described range, even if the temperature of the melted chocolate is high (e.g., 32 to 40° C.) and the chocolate is held under such a high temperature, a stable seeding effect can be expected. After the β-type XOX crystals have been added to the melted chocolate, the β-type XOX crystals may be uniformed dispersed in the chocolate mix by stirring, for example. Note that the XOX content in the fats and oils of the seeding agent is taken as the β-type XOX crystal content in the fats and oils.

Moreover, in the case of performing the seeding treatment in the method for manufacturing the chocolate of the present invention, the temperature of the melted chocolate is preferably 32 to 40° C. The temperature of the chocolate mix is held at 32 to 40° C. so that an increase in the viscosity of the chocolate can be suppressed. The temperature of the melted chocolate is preferably 34 to 39° C., more preferably 35 to 39° C., and most preferably 37 to 39° C. When the temperature of the chocolate in the seeding treatment is high, the addition amount of the seeding agent containing at least the β-type XOX crystals is increased so that the seeding treatment can be efficiently performed.

Further, in the case of performing the seeding treatment, the method for manufacturing the chocolate of the present invention further includes the seeding treatment and the water addition process. Note that any of these processes may be first performed in such a sequence. Alternatively, the seeding agent addition process and the water addition process may be simultaneously performed (i.e., the seeding agent and the water may be simultaneously added to the melted chocolate).

The chocolate resulted from the manufacturing method of the present invention is, without any changes, edible as molded chocolate after each of the above-described processes has performed. Moreover, the chocolate of the present invention can be used as coatings, fillings, or chips to be mixed with doughs of confectionery and bakery products (e.g., breads, cakes, western confectioneries, baked confectioneries, doughnuts, and cream puff cakes), for example. As described above, various chocolate composite food products (food products each containing chocolate as part of a raw material) can be provided.

### EXAMPLES

The present invention will be described in more detail below with reference to examples.

[Raw Materials of Chocolate]

The following materials were used as main raw materials of the chocolate:

cocoa butter (manufactured by Daito Cacao Co., Ltd. and product name: TC Cocoa Butter);

StOSt fats and oils (a StOSt content of 67.3 mass % and manufactured by Nisshin Oillio Group, Ltd.);

HPKS (fully-hydrogenated palm kernel stearin oil and manufactured by Intercontinental Specialty Fats Sdn. Bhd. in Malaysia);

cacao mass (manufactured by Daito Cacao Co., Ltd. and product name: Cacao Mass QM-P);

cocoa powder (manufactured by Daito Cacao Co., Ltd. and product name: Cocoa Powder JA);

sugar (manufactured by Tokukura Corporation and product name: POWDER SUGAR)

lactose (manufactured by LIPRINO FOODS and product name: Lactose);

whole milk powder (manufactured by Yotsuba Milk Products Co., Ltd. and product name: Whole Milk Powder);

skimmed milk powder (manufactured by Morinaga Milk Industry Co., Ltd. and product name: Skimmed Milk Powder);

lecithin (manufactured by Nisshin Oillio Group, Ltd. and product name: Lecithin DX); and

PGPR (polyglycerin condensed-ricinoleic acid ester manufactured by Taiyo Kagaku Co., Ltd.).

[Water-Containing Material]

The following material was used as the water-containing material:

liquid sugar (a moisture of 25 mass % and fructose glucose liquid sugar manufactured by Showa Sangyo Co., Ltd.).

Moreover, the water content in each chocolate piece was measured by a normal pressure drying method.

[Seeding Agent]

The following material was used as the seeding agent: a seeding agent A (a β-type StOSt crystal content of 33 mass % and manufactured by Nisshin Oillio Group, Ltd.).

[Hexane Dipping Test]

A hexane dipping test for the chocolate was performed as follows.

The chocolate was placed on a diamond-shaped stainless net having a long-side distance of 16 mm and a short-side distance of 8 mm and having intersections of 60° and 120°. The stainless net on which the chocolate is placed was dipped in n-hexane at 20° C. Then, the shape of the chocolate was observed after a lapse of 48 hours. According to such a shape, a result was evaluated as follows. More shape retention of the chocolate results in formation of a stronger sugar network (skeleton).

Excellent: an original shape fully remains;

Good: the chocolate is misshapen, but more than the half of the shape remains;

Fair: residues remain; and

Poor: the chocolate is fully dropped.

[Measurement of Resistance to Stress Under Load]

The resistance to stress under load of the chocolate was measured as follows.

Chocolate temperature-adjusted to 34° C. and having a thickness of 7 mm was used as a measurement sample. The resistance to stress under load (in units of g) was measured using a Rheometer CR-500DX (manufactured by Sun Scientific Co., Ltd.) under conditions including a table moving speed of 20 mm/min, a fixed depth of 3.0 mm, and a plunger diameter of 3 mm. A greater value of the resistance to stress under load results in a stronger sugar network (skeleton).

[Manufacturing and Evaluation of Chocolate—1]

### First Comparative Example

After raw materials have been mixed together according to a composition of Table 1, roll refining and conching were performed according to a common procedure. Melted chocolate A (a fats and oils content of 33.0 mass %) having a temperature of 37° C. was prepared. Then, 1.0 mass % (a β-type StOSt crystal content of 0.33 mass % with respect to fats and oils in the chocolate A) of a seeding agent A was added to the fats and oils in the chocolate A, and was stirred and dispersed. Subsequently, a polycarbonate mold was filled with the chocolate A containing the seeding agent A, and then, the chocolate A was cooled and solidified at 8° C. The chocolate A removed from the mold and having a thickness of 7 mm was left standing (aged) for 24 hours at 20° C., and was provided for the hexane dipping test and the resistance to stress under load measurement. Results are shown in Table 2.

### Second Comparative Example

After raw materials have been mixed together according to a composition of Table 1, roll refining and conching were performed according to a common procedure. Melted chocolate A (a fats and oils content of 33.0 mass %) having a temperature of 37° C. was prepared. Then, 4 mass % (a water content of 1.0 mass % with respect to the chocolate A) of liquid sugar (a moisture content of 25 mass %) was added to the chocolate A, and was stirred and dispersed. Subsequently, 1.0 mass % (a β-type StOSt crystal content of 0.33 mass % with respect to fats and oils in the chocolate A) of a seeding agent A was, still at a chocolate temperature of 37° C., added to the fats and oils in the chocolate A, and was stirred and dispersed. Then, a polycarbonate mold was filled with the chocolate A containing the liquid sugar and the seeding agent A, and then, the chocolate A was cooled and solidified at 8° C. The chocolate A removed from the mold and having a thickness of 7 mm was left standing (aged) for 24 hours at 20° C., and was provided for the hexane dipping test and the resistance to stress under load measurement. Results are shown in Table 2.

### Third Comparative Example

After raw materials have been mixed together according to a composition of Table 1, roll refining and conching were performed according to a common procedure. Melted chocolate B (a fats and oils content of 33.0 mass %) having a temperature of 34° C. was prepared. Then, 4 mass % (a water content of 1.0 mass % with respect to the chocolate B) of liquid sugar (a moisture content of 25 mass %) was added to the chocolate B, and was stirred and dispersed. Subsequently, 1.0 mass % (a β-type StOSt crystal content of 0.33 mass % with respect to fats and oils in the chocolate B) of a seeding agent A was, still at a chocolate temperature of 34° C., added to the fats and oils in the chocolate B, and was stirred and dispersed. Then, a polycarbonate mold was filled with the chocolate B containing the liquid sugar and the seeding agent A, and then, the chocolate B was cooled and solidified at 8° C. The chocolate B removed from the mold and having a thickness of 7 mm was left standing (aged) for 24 hours at 20° C., and was provided for the hexane dipping test and the resistance to stress under load measurement. Results are shown in Table 2.

### First Example

After raw materials have been mixed together according to a composition of Table 1, roll refining and conching were performed according to a common procedure. Melted chocolate C (a fats and oils content of 33.0 mass %) having a temperature of 37° C. was prepared. Then, 4 mass % (a water content of 1.0 mass % with respect to the chocolate C) of liquid sugar (a moisture content of 25 mass %) was added to the chocolate C, and was stirred and dispersed. Subsequently, 1.0 mass % (a β-type StOSt crystal content of 0.33 mass % with respect to fats and oils in the chocolate B) of a seeding agent A was, still at a chocolate temperature of 37° C., added to fats and oils in the chocolate C, and was stirred and dispersed. Then, a polycarbonate mold was filled with the chocolate C containing the liquid sugar and the seeding agent A, and then, the chocolate C was cooled and solidified at 8° C. The chocolate C removed from the mold and having a thickness of 7 mm was left standing (aged) for 24 hours at 20° C., and was provided for the hexane dipping test and the resistance to stress under load measurement. Results are shown in Table 2.

TABLE 1
Compositions of Chocolates A, B, C (in units of mass %)

| | Chocolate A | Chocolate B | Chocolate C |
|---|---|---|---|
| Cocoa Butter | 17.33 | 30.78 | 17.33 |
| StOSt in Fats and | 11.67 | — | 11.67 |
| Oils | | | |
| Cocoa Powder | — | 20.22 | — |
| Sugar (Sucrose) | 44.55 | 44.55 | 40.55 |
| Lactose | — | 4.00 | 4.00 |
| Whole Milk Powder | 16.00 | — | 16.00 |
| Skimmed Milk | 10.00 | — | 10.00 |
| Powder | | | |
| Lecithin | 0.27 | 0.27 | 0.27 |
| PGPR | 0.13 | 0.13 | 0.13 |
| Flavor | 0.05 | 0.05 | 0.05 |
| Total | 100.0 | 100.0 | 100.0 |
| Fats and Oils | 33.0 | 33.0 | 33.0 |
| Content | | | |
| SOS Content in | 73.4 | 85.3 | 73.4 |
| Fats and Oils | | | |
| StOSt Content in | 39.1 | 29.1 | 39.1 |
| Fats and Oils | | | |

TABLE 2
Chocolate Manufacturing Conditions and Evaluation Results

| | First | Second | Third | |
|---|---|---|---|---|
| | Comparative | Comparative | Comparative | First |
| | Example | Example | Example | Example |
| Chocolate | A | A | B | C |
| Composition | | | | |
| Water-Containing | — | Liquid | Liquid | Liquid |
| Material | | Sugar | Sugar | Sugar |
| Water Content | 0.4 | 1.5 | 1.2 | 1.5 |
| (mass %) in | | | | |
| Chocolate | | | | |
| Hexane Dipping Test | Poor | Good | Good | Excellent |
| Resistance to stress | 85 | 94 | 4 | 293 |
| under load (g) | | | | |

[Manufacturing and Evaluation of Chocolate—2]

### Fourth Comparative Example

After raw materials have been mixed together according to a composition of Table 3, roll refining and conching were performed according to a common procedure. Melted chocolate D (a fats and oils content of 37.0 mass %) having a temperature of 37° C. was prepared. Then, 4 mass % (a water content of 1.0 mass % with respect to the chocolate D) of liquid sugar (a moisture content of 25 mass %) was added to the chocolate D, and was stirred and dispersed. Subsequently, 1.0 mass % (a β-type StOSt crystal content of 0.33 mass % with respect to fats and oils in the chocolate D) of a seeding agent A was, still at a chocolate temperature of 37° C., added to the fats and oils in the chocolate D, and was stirred and dispersed. Then, a polycarbonate mold was filled with the chocolate D containing the liquid sugar and the seeding agent A, and then, the chocolate D was cooled and solidified at 8° C. The chocolate D removed from the mold and having a thickness of 7 mm was left standing (pre-aged) for 48 hours at 20° C., and then, was left standing (subjected to the heat retention process) for 96 hours at 28° C. Further, the chocolate D was left standing (aged) for 168 hours at 20° C., and was provided for the hexane dipping test and the resistance to stress under load measurement. Results are shown in Table 4.

### Second Example

After raw materials have been mixed together according to a composition of Table 3, roll refining and conching were performed according to a common procedure. Melted chocolate E (a fats and oils content of 37.0 mass %) having a temperature of 37° C. was prepared. Then, 4 mass % (a water content of 1.0 mass % with respect to the chocolate E) of liquid sugar (a moisture content of 25 mass %) was added to the chocolate E, and was stirred and dispersed. Subsequently, 1.0 mass % (a β-type StOSt crystal content of 0.33 mass % with respect to fats and oils in the chocolate E) of a seeding agent A was, still at a chocolate temperature of 37° C., added to the fats and oils in the chocolate E, and was stirred and dispersed. Then, a polycarbonate mold was filled with the chocolate E containing the liquid sugar and the seeding agent A, and then, the chocolate E was cooled and solidified at 8° C. The chocolate E removed from the mold and having a thickness of 7 mm was left standing (pre-aged) for 48 hours at 20° C., and then, was left standing (subjected to the heat retention process) for 96 hours at 28° C. Further, the chocolate E was left standing (aged) for 168 hours at 20° C., and was provided for the hexane dipping test and the resistance to stress under load measurement. Results are shown in Table 4.

TABLE 3
Compositions of Chocolates D, E (in units of mass %)

| | Chocolate D | Chocolate E |
|---|---|---|
| Cocoa Butter | 20.27 | 20.27 |
| StOSt in Fats and Oils | 12.73 | 12.73 |
| Sugar (Sucrose) | 44.55 | 40.55 |
| Lactose | — | 4.00 |
| Whole Milk Powder | 16.00 | 16.00 |
| Skimmed Milk Powder | 6.00 | 6.00 |
| Lecithin | 0.40 | 0.40 |
| Flavor | 0.05 | 0.05 |
| Total | 100.0 | 100.0 |
| Fats and Oils | 37.0 | 37.0 |
| Content | | |
| SOS Content in | 74.6 | 74.6 |
| Fats and Oils | | |
| StOSt Content in | 39.1 | 39.1 |
| Fats and Oils | | |

TABLE 4
Chocolate Manufacturing Conditions and Evaluation Results

| | Fourth Comparative | Second |
|---|---|---|
| | Example | Example |
| Chocolate Composition | D | E |
| Water-Containing Material | Liquid Sugar | Liquid Sugar |
| Water Content (mass %) in Chocolate | 1.4 | 1.4 |
| Hexane Dipping Test | Excellent | Excellent |
| Resistance to stress under load (g) | 97 | 152 |

[Manufacturing and Evaluation of Chocolate—3]

### Fifth Comparative Example

After raw materials have been mixed together according to a composition of Table 5, roll refining and conching were performed according to a common procedure. Melted chocolate F (a fats and oils content of 35.0 mass %) having a temperature of 37° C. was prepared. Then, 4 mass % (a water content of 1.0 mass % with respect to the chocolate F) of liquid sugar (a moisture content of 25 mass %) was added to the chocolate F, and was stirred and dispersed. Subsequently, 1.0 mass % (a β-type StOSt crystal content of 0.33 mass % with respect to fats and oils in the chocolate F) of a seeding agent A was, still at a chocolate temperature of 37° C., added to the fats and oils in the chocolate F, and was stirred and dispersed. Then, a polycarbonate mold was filled with the chocolate F containing the liquid sugar and the seeding agent A, and then, the chocolate F was cooled and solidified at 8° C. The chocolate F removed from the mold and having a thickness of 7 mm was left standing (pre-aged) for 24 hours at 20° C., and then, was left standing (subjected to the heat retention process) for 96 hours at 28° C. Further, the chocolate F was left standing (aged) for 168 hours at 20° C., and was provided for the hexane dipping test and the resistance to stress under load measurement. Results are shown in Table 6.

### Third Example

After raw materials have been mixed together according to a composition of Table 5, roll refining and conching were performed according to a common procedure. Melted chocolate G (a fats and oils content of 35.0 mass %) having a temperature of 37° C. was prepared. Then, 4 mass % (a water content of 1.0 mass % with respect to the chocolate G) of liquid sugar (a moisture content of 25 mass %) was added to the chocolate G, and was stirred and dispersed. Subsequently, 1.0 mass % (a β-type StOSt crystal content of 0.33 mass % with respect to fats and oils in the chocolate G) of a seeding agent A was, still at a chocolate temperature of 37° C., added to the fats and oils in the chocolate G, and was stirred and dispersed. Then, a polycarbonate mold was filled with the chocolate G containing the liquid sugar and the seeding agent A, and then, the chocolate G was cooled and solidified at 8° C. The chocolate G removed from the mold and having a thickness of 7 mm was left standing (pre-aged) for 24 hours at 20° C., and then, was left standing (subjected to the heat retention process) for 96 hours at 28° C. Further, the chocolate G was left standing (aged) for 168 hours at 20° C., and was provided for the hexane dipping test and the resistance to stress under load measurement. Results are shown in Table 6.

TABLE 5
Compositions of Chocolates F, G (in units of mass %)

| | Chocolate F | Chocolate G |
|---|---|---|
| Cocoa Butter | 10.47 | 10.47 |
| StOSt in Fats and Oils | 11.53 | 11.53 |
| Cacao Mass | 18.00 | 18.00 |
| Sugar (Sucrose) | 47.15 | 43.15 |
| Lactose | — | 4.00 |
| Whole Milk Powder | 12.40 | 12.40 |
| Lecithin | 0.27 | 0.27 |
| PGPR | 0.13 | 0.13 |
| Flavor | 0.05 | 0.05 |
| Total | 100.0 | 100.0 |
| Fats and Oils | 35.0 | 35.0 |
| Content | | |
| SOS Content in | 76.3 | 76.3 |
| Fats and Oils | | |
| StOSt Content in | 39.1 | 39.1 |
| Fats and Oils | | |

TABLE 6
Chocolate Manufacturing Conditions and Evaluation Results

| | Fifth Comparative | Third |
|---|---|---|
| | Example | Example |
| Chocolate Composition | F | G |
| Water-Containing Material | Liquid Sugar | Liquid Sugar |
| Water Content (mass %) in Chocolate | 1.2 | 1.2 |
| Hexane Dipping Test | Excellent | Excellent |
| Resistance to stress under load (g) | 79 | 130 |

[Manufacturing and Evaluation of Chocolate—4]

### Sixth Comparative Example

After raw materials have been mixed together according to a composition of Table 7, roll refining and conching were performed according to a common procedure. Melted chocolate H (a fats and oils content of 33.0 mass %) having a temperature of 40° C. was prepared. Then, 4 mass % (a water content of 1.0 mass % with respect to the chocolate H) of liquid sugar (a moisture content of 25 mass %) was added to the chocolate H, and was stirred and dispersed. Subsequently, a polycarbonate mold was filled with the chocolate H containing the liquid sugar, and then, the chocolate H was cooled and solidified at 8° C. The chocolate H removed from the mold and having a thickness of 7 mm was left standing (pre-aged) for 24 hours at 20° C., and then, was left standing (subjected to the heat retention process) for 24 hours at 28° C. Subsequently, the chocolate H was provided for the hexane dipping test and the resistance to stress under load measurement. Results are shown in Table 8.

### Fourth Example

After raw materials have been mixed together according to a composition of Table 7, roll refining and conching were performed according to a common procedure. Melted chocolate I (a fats and oils content of 33.0 mass %) having a temperature of 40° C. was prepared. Then, 4 mass % (a water content of 1.0 mass % with respect to the chocolate G) of liquid sugar (a moisture content of 25 mass %) was added to the chocolate I, and was stirred and dispersed. Subsequently, a polycarbonate mold was filled with the chocolate I containing the liquid sugar, and then, the chocolate I was cooled and solidified at 8° C. The chocolate I removed from the mold and having a thickness of 7 mm was left standing (pre-aged) for 24 hours at 20° C., and then, was left standing (subjected to the heat retention process) for 24 hours at 28° C. Subsequently, the chocolate I was provided for the hexane dipping test and the resistance to stress under load measurement. Results are shown in Table 8.

TABLE 7
Compositions of Chocolates H, I (in units of mass %)

| | Chocolate H | Chocolate I |
|---|---|---|
| HPKS | 31.35 | 31.35 |
| Cacao Mass | 1.50 | 1.50 |
| Cocoa Powder | 7.50 | 7.50 |
| Sugar (Sucrose) | 49.20 | 44.20 |
| Lactose | — | 5.00 |
| Skimmed Milk Powder | 10.00 | 10.00 |
| Lecithin | 0.27 | 0.27 |
| PGPR | 0.13 | 0.13 |
| Flavor | 0.05 | 0.05 |
| Total | 100.0 | 100.0 |
| Fats and Oils Content | 33.0 | 33.0 |

TABLE 8
Chocolate Manufacturing Conditions and Evaluation Results

| | Sixth Comparative | Fourth |
|---|---|---|
| | Example | Example |
| Chocolate Composition | H | I |
| Water-Containing Material | Liquid Sugar | Liquid Sugar |
| Water Content (mass %) in Chocolate | 1.7 | 1.7 |
| Hexane Dipping Test | Good | Excellent |
| Resistance to stress under load (g) | 84 | 121 |

[Manufacturing and Evaluation of Chocolate—5]

### Fifth Example

After raw materials have been mixed together according to a composition of Table 9, roll refining and conching were performed according to a common procedure. Melted chocolate J (a fats and oils content of 33.0 mass %) having a temperature of 37° C. was prepared. Then, 4 mass % (a water content of 1.0 mass % with respect to the chocolate J) of liquid sugar (a moisture content of 25 mass %) was added to the chocolate J, and was stirred and dispersed. Subsequently, 1.0 mass % (a β-type StOSt crystal content of 0.33 mass % with respect to fats and oils in the chocolate J) of a seeding agent A was, still at a chocolate temperature of 37° C., added to the fats and oils in the chocolate J, and was stirred and dispersed. Then, a polycarbonate mold was filled with the chocolate J containing the liquid sugar and the seeding agent A, and then, the chocolate J was cooled and solidified at 8° C. The chocolate removed from the mold and having a thickness of 7 mm was left standing (aged) for 24 hours at 20° C., and then, was left standing (subjected to the heat retention process) for 192 hours at 28° C. Further, the chocolate J was left standing (aged) for 168 hours at 20° C., and was provided for the hexane dipping test and the resistance to stress under load measurement. Results are shown in Table 10.

TABLE 9
Composition of Chocolate (in units of mass %)

| | Chocolate J |
|---|---|
| Cocoa butter | 9.00 |
| Fats and Oils in StOSt | 11.00 |
| Cacao Mass | 18.00 |
| Sugar (Sucrose) | 39.25 |
| Lactose | 10.00 |
| Whole Milk Powder | 12.40 |
| Lecithin | 0.20 |
| PGPR | 0.10 |
| Flavor | 0.05 |
| Total | 100.0 |
| Fats and Oils | 33.0 |
| Content | |
| SOS Content in | 75.5 |
| Fats and Oils | |
| StOSt Content in | 39.1 |
| Fats and Oils | |

TABLE 10
Chocolate Manufacturing Conditions and Evaluation Results

| | Fifth Example |
|---|---|
| Chocolate Composition | J |
| Water-Containing Material | Liquid Sugar |
| Water Content (mass %) in Chocolate | 1.3 |
| Hexane Dipping Test | Excellent |
| Resistance to stress under load (g) | 320 |

1. Chocolate having a sugar skeleton, comprising:
(a) 28 to 44 mass % of fats and oils;
(b) 30 to 58 mass % of sucrose;
(c) 1 to 20 mass % of lactose; and (d) 4 to 32 mass % of powdered milk.

2. The chocolate according to claim 1, wherein a shape of the chocolate is retained for equal to or longer than 24 hours in a state in which the chocolate is dipped in n-hexane at 20° C.

3. The chocolate according to claim 1, wherein the chocolate has resistance to stress under load of equal to or greater than 100 g, the resistance to stress under load being measured in such a manner that chocolate temperature-adjusted to 34° C. and having a thickness of 7 mm is measured using a rheometer under conditions including a table moving speed of 20 mm/min, a fixed depth of 3.0 mm, and a plunger diameter of 3 mm.

4. The chocolate according to claim 1, wherein the powdered milk is skimmed milk powder and/or whole milk powder.

5. A method for manufacturing chocolate having a sugar skeleton, comprising a process of adding and dispersing 0.3 to 3.0 mass % of water with respect to 100 parts by mass of melted chocolate and then cooling and solidifying the melted chocolate, the melted chocolate containing
(a) 28 to 44 mass % of fats and oils,
(b) 30 to 58 mass % of sucrose,
(c) 1 to 20 mass % of lactose, and
(d) 4 to 32 mass % of powdered milk.

6. The method for manufacturing the chocolate having the sugar skeleton according to claim 5, further comprising a heat retention process of heat-retaining the chocolate after the cooling and solidifying process.

7. The chocolate according to claim 2, wherein the chocolate has resistance to stress under load of equal to or greater than 100 g, the resistance to stress under load being measured in such a manner that chocolate temperature-adjusted to 34° C. and having a thickness of 7 mm is measured using a rheometer under conditions including a table moving speed of 20 mm/min, a fixed depth of 3.0 mm, and a plunger diameter of 3 mm.

8. The chocolate according to claim 2, wherein the powdered milk is skimmed milk powder and/or whole milk powder.

9. The chocolate according to claim 3, wherein the powdered milk is skimmed milk powder and/or whole milk powder.

10. The chocolate according to claim 7, wherein the powdered milk is skimmed milk powder and/or whole milk powder.
